(19) United States
(12) Patent Application Publication
(10) Pub. No.: US 2015/0251452 A1
(43) Pub. Date: Sep. 10, 2015

(54) RECORDING DEVICE AND RECORDING METHOD

(71) Applicant: Fuji Xerox Co., Ltd., Tokyo (JP)

(72) Inventors: Mami HATANAKA, Kanagawa (JP); Hiroyuki UEKI, Kanagawa (JP); Toshitake YUI, Kanagawa (JP)

(21) Appl. No.: 14/625,699

(22) Filed: Feb. 19, 2015

(30) Foreign Application Priority Data
Mar. 5, 2014 (JP) 2014-043240

(51) Int. Cl. B41J 11/00

(52) U.S. Cl. CPC B41J 11/002

(57) ABSTRACT

A recording device includes an ejection head that ejects aqueous ink including a colorant, polymer particles, a light-absorbing and heat-generating agent, water, and an aqueous organic solvent, and a light irradiation device that irradiates the aqueous ink with light within one second after the aqueous ink ejected from the ejection head lands.

### CROSS-REFERENCE TO RELATED APPLICATIONS

This application is based on and claims priority under 35 USC 119 from Japanese Patent Application No. 2014-043240 filed Mar. 5, 2014.

### BACKGROUND

### Technical Field

The present invention relates to a recording device and a recording method.

### SUMMARY

According to an aspect of the invention, there is provided a recording device including:

an ejection head that ejects aqueous ink including a colorant, polymer particles, a light-absorbing and heat-generating agent, water, and an aqueous organic solvent; and

a light irradiation device that irradiates the aqueous ink with light within one second after the aqueous ink ejected from the ejection head lands.

### BRIEF DESCRIPTION OF THE DRAWINGS

Exemplary embodiments of the present invention will be described in detail based on the following figures, wherein:

FIG. 1 is a diagram schematically illustrating a recording device according to an exemplary embodiment;

FIGS. 2A to 2C are diagrams schematically illustrating a mechanism in which a stripe-shaped image defect occurs by landing interference of ink droplets. FIG. 2A is a diagram schematically illustrating a state just before subsequently landed ink lands on a recording medium. FIG. 2B is a diagram schematically illustrating a state in which the landing interference of the ink droplets is generated and the stripe-shaped image defect occurs. FIG. 2C is a diagram schematically illustrating a state in which the landing interference of the ink droplets is not generated and the stripe-shaped image defect does not occur; and

FIGS. 3A and 3B are diagrams schematically illustrating states in which ink droplets of the recording device according to the exemplary embodiment land. FIG. 3A is a diagram schematically illustrating a state just after a subsequent ink drop lands. FIG. 3B is a diagram schematically illustrating a state that after the subsequent ink droplet lands, a previous ink droplet and the subsequent ink droplet are coalesced.

### DETAILED DESCRIPTION

Hereinafter, an exemplary embodiment which is an example of the invention is described in detail.

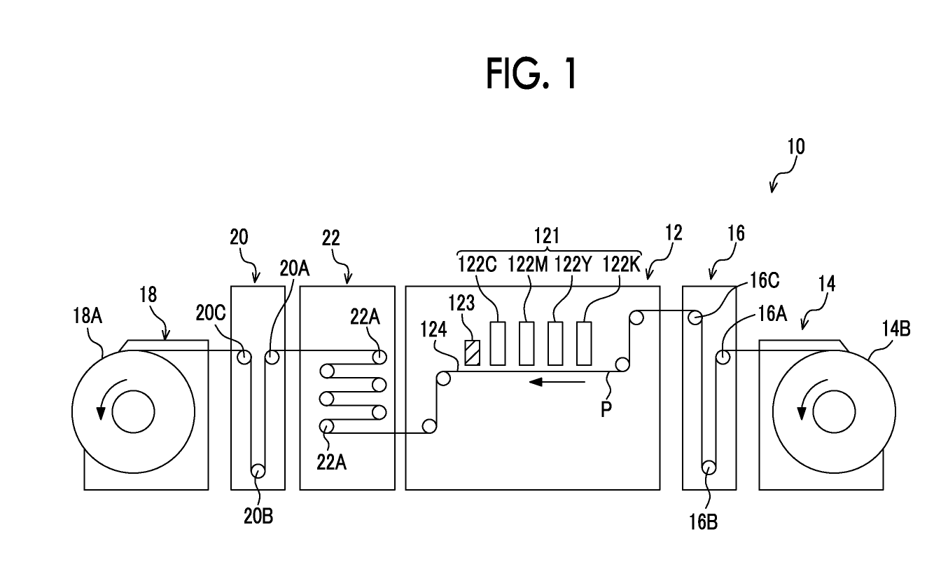

FIG. 1 is a diagram schematically illustrating a recording device according to the exemplary embodiment.

As illustrated in FIG. 1, a recording device 10 according to the exemplary embodiment is a recording device including ejection heads 122 that eject aqueous ink (hereinafter, referred to as “ink”) to a non-permeable recording medium P (an ejection device 121 including the ejection heads 122). In the recording device 10 according to the exemplary embodiment, a recording method including an ejecting process of ejecting ink to a non-permeable recording medium P is obtained. Accordingly, an image is recorded by the ink on the non-permeable recording medium P.

Specifically, the recording device 10 according to the exemplary embodiment includes the image recording unit 12 that records an image, for example, on continuous paper (hereinafter, also referred to as “continuous paper P”) as the non-permeable recording medium P.

The recording device 10 includes a pre-processing unit 14 in which the continuous paper P fed to an image recording unit 12 is accommodated, and a buffer unit 16 that adjusts a feeding amount of the continuous paper P fed from the pre-processing unit 14 to the image recording unit 12. The buffer unit 16 is provided between the image recording unit 12 and the pre-processing unit 14.

The recording device 10 includes, for example, a post-processing unit 18 in which the continuous paper P discharged from the image recording unit 12 is accommodated, and a buffer unit 20 that adjusts the feeding amount of the continuous paper P discharged from the image recording unit 12 to the post-processing unit 18. The buffer unit 20 is arranged between the image recording unit 12 and the post-processing unit 18.

The recording device 10 includes a cooling unit 22 which is arranged between the image recording unit 12 and the buffer unit 20, and cools down the continuous paper P discharged from the image recording unit 12.

The image recording unit 12 includes, for example, roller members (reference numerals are omitted) that guide the continuous paper P along a transporting path 124 of the continuous paper P, and the ejection device 121 that records the image by ejecting ink (ink droplets) to the continuous paper P transported along the transporting path 124 of the continuous paper P.

The ejection device 121 includes the ejection heads 122 that eject ink to the continuous paper P. The ejection heads 122 are long recording heads of which effective recordable regions (arrangement region of nozzles that eject ink) have a size equal to or longer than the width of the continuous paper P (length of the continuous paper P in a direction intersecting (for example, orthogonal to) the transportation direction).

In addition, the ejection heads 122 are not limited thereto, but may be ejection heads shorter than the width of the continuous paper P, and may be ejection heads of a type ejecting ink while moving in the width direction of the continuous paper P (so-called carriage type).

The ejection heads 122 may be of a so-called thermal type ejecting ink droplets by heat, and may be of a so-called piezoelectric type ejecting ink droplets by pressure. A well-known type of ejection head is applied.

The ejection head 122 includes, for example, an ejection head 122K that records a K (black) image by ejecting ink to the continuous paper P, an ejection head 122Y that records a Y (yellow) image, an ejection head 122M that records an M (magenta) image, and an ejection head 122C that records a C (cyan) image. Also, the ejection head 122K, the ejection head 122Y, the ejection head 122M, and the ejection head 122C are arranged in a line to face the continuous paper P from the upstream side to the downstream side in the transportation direction of the continuous paper P (also simply referred to as “paper transportation direction”) in this order. In addition, in the description of the ejection head, when K, Y, M, and C are not distinguished, K, Y, M, and C added to the reference numerals are omitted.

The ejection heads 122 are not limited to a form in which four ejection heads 122 corresponding to four colors are arranged, and four or more ejection heads 122 corresponding to four or more colors including other neutral colors may be arranged according to the purpose.

Here, the ejection heads 122 may include, for example, any one of a low resolution ejection head 122 (for example, an ejection head of 600 dpi) that ejects ink of an ink droplet amount in the range of 10 pl to 15 pl, and a high resolution ejection head 122 (for example, an ejection head of 1,200 dpi) that ejects ink of an ink droplet amount less than 10 pl. In addition, the ejection device 121 may include both of the low resolution ejection head 122 and the high resolution ejection head 122. The ink droplet amount of the ejection head 122 is in a range of the maximum droplet amount of the ink. In addition, the abbreviation “dpi” refers to “dots per inch”.

In the ejection device 121, a light irradiation device 123 with which, after the ink ejected from the ejection heads 122 lands on the continuous paper P, the landed ink is irradiated with light within 1 second, is arranged on the downstream side of the ejection head 122 in the paper transportation direction. The ink is dried by the light irradiation of the light irradiation device 123.

Here, the expression “the landed ink is irradiated with light within 1 second after landing” means that the ink (ink droplets) all landing on the continuous paper P (the recording medium P) is irradiated with light within 1 second after landing. Specifically, in the ejection device 121, a drop of the ink landing earliest on the continuous paper P (the recording medium P) is irradiated with light within 1 second after landing.

In addition, when the light irradiation devices 123 are respectively arranged on the plural ejection heads 122 on the downstream in the paper transportation direction, in each of the ejection heads 122, a drop of the ink landing earliest on the continuous paper P (the recording medium P) is irradiated with light within 1 second after landing.

As the light irradiation device 123, for example, an infrared irradiation device, and an ultraviolet irradiation device are included. The types of the light irradiation device 123 are selected according to the type of a light-absorbing and heat-generating agent included in the ink.

The light irradiation device 123 is, for example, a long light irradiation device of which effective light irradiation regions (arrangement region of light source) have a size equal to or longer than the width of the recordable region with respect to the ejection heads 122 (length of the continuous paper P in a direction intersecting (for example, orthogonal to) the transportation direction).

In addition, the light irradiation device 123 is not limited thereto, but may be a light irradiation device shorter than the width of the recordable region with respect to the ejection heads 122, and may be a light irradiation device of a type irradiating the ink with light while moving in the width direction of the recordable region with respect to the ejection heads 122 (so-called carriage type).

For example, as the light source of the infrared irradiation device, for example, a light emitting diode (LED) and a semiconductor laser (LD, VCSEL (surface emitting type semiconductor laser)) are included. Among these, the light source of the infrared irradiation device may preferably be the semiconductor laser (LD, VCSEL) with high irradiation energy density.

The infrared light irradiation conditions of the infrared irradiation device change according to the infrared absorbing function of a light-absorbing and heat-generating agent (infrared light absorbing agent) included in the ink, or the like but, for example, the center wavelength may be in the range of 700 nm to 1,200 nm (preferably in the range of 780 nm to 980 nm), the irradiation intensity may be in the range of 0.1 J/cm² to 10 J/cm² (preferably in the range of 1 J/cm² to 3 J/cm²), and the irradiation time may be in the range of 0.1 milliseconds to 10 seconds (preferably in the range of 10 milliseconds to 100 milliseconds).

As the light source of the ultraviolet light irradiation device, for example, mercury lamps (for example, low pressure, medium pressure, and high pressure mercury lamps having operating pressures from several 100 Pa to 1 MPa), a metal halide lamp, a xenon lamp, a cold cathode tube, a hot cathode tube, a light emitting diode (LED), a semiconductor laser (LD, VCSEL), and a wavelength conversion laser light source are included. Among these, the light source of the ultraviolet light irradiation device may preferably be the semiconductor laser (LD, VCSEL) with high irradiation energy density.

The ultraviolet light irradiation conditions of the ultraviolet light irradiation device change according to the ultraviolet light absorbing function of a light-absorbing and heat-generating agent (ultraviolet light absorbing agent) included in the ink, or the like but the center wavelength may be in the range of 300 nm to 420 nm (preferably in the range of 350 nm to 400 nm), the irradiation intensity may be in the range of 10 mJ/m² to 5,000 mJ/m² (preferably in the range of 50 mJ/m² to 500 mJ/m²), and the irradiation time may be in the range of 0.1 milliseconds to 10 seconds (preferably in the range of 10 milliseconds to 100 milliseconds).

Though not illustrated in the drawings, in the ejection device 121, in addition to the light irradiation device 123, a drying drum (an example of a drying device) that winds the continuous paper P from the rear surface, and dries the image (ink) on the continuous paper P while being driven and rotated in contact with the transported continuous paper P may be arranged on the downstream side in the paper transportation direction of the ejection heads 122 (the light irradiation device 123).

Though not illustrated in the drawings, in the ejection device 121, in addition to the light irradiation device 123, a warm air blowing device (an example of a drying device) and a near infrared heater that dry the image (ink) on the continuous paper P may be arranged on the downstream side in the paper transportation direction of the ejection heads 122 (the light irradiation device 123).

Meanwhile, the pre-processing unit 14 includes a feeding roller 14A around which the continuous paper P to be fed to the image recording unit 12 is wound, and the feeding roller 14A is rotatably supported by a frame member (not illustrated).

In the buffer unit 16, for example, a first pass roller 16A, a dancer roller 16B, and a second pass roller 16C are arranged in the paper transportation direction. While moving in the vertical direction of FIG. 1, the dancer roller 16B adjusts the tension of the continuous paper P transported to the image recording unit 12 and adjusts the feeding amount of the continuous paper P.

The post-processing unit 18 includes a winding roller 18A as an example of a transporting portion that winds the continuous paper P on which the image is recorded. The winding roller 18A rotates by receiving torque from a motor (not illustrated) to transport the continuous paper P along the transporting path 124.

In the buffer unit 20, for example, a first pass roller 20A, a dancer roller 20B, and a second pass roller 20C are arranged in the paper transportation direction. While moving in the vertical direction of FIG. 1, the dancer roller 20B adjusts the tension of the continuous paper P to be discharged to the post-processing unit 18, and adjusts the feeding amount of the continuous paper P.

In the cooling unit 22, plural cooling rollers 22A are arranged. The continuous paper P is cooled down by being transported between the plural cooling rollers 22A.

Next, the operation of the recording device 10 according to the exemplary embodiment (recording method) is described.

In the recording device 10 according to the exemplary embodiment, the continuous paper P is first transported from the feeding roller 14A of the pre-processing unit 14 to the image recording unit 12 through the buffer unit 16.

Then, in the image recording unit 12, the ink is ejected from the respective ejection heads 122 of the ejection device 121 to the continuous paper P. Accordingly, the image is formed with ink on the continuous paper P.

Then, after the ink ejected from the respective ejection heads 122 lands on the continuous paper P, the landed ink is irradiated with light by the light irradiation device 123 within 1 second. Accordingly, the image (ink) on the continuous paper P is dried.

Then, in the cooling unit 22, the continuous paper P on which the image is recorded is cooled down by the cooling rollers 22A.

Then, through the buffer unit 20, the post-processing unit 18 winds the continuous paper P on which the image is recorded, around the winding roller 18A.

According to the processes described above, the image is recorded with the ink on the continuous paper P as the non-permeable recording medium P.

In addition, as the non-permeable recording medium P, coated paper, a resin film, or the like are included. Specifically, the non-permeable recording medium P means a recording medium of which the maximum liquid absorption amount of the ink measured by a dynamic scanning liquid absorptometer within the contact time of 500 ms is equal to or less than 15 ml/m².

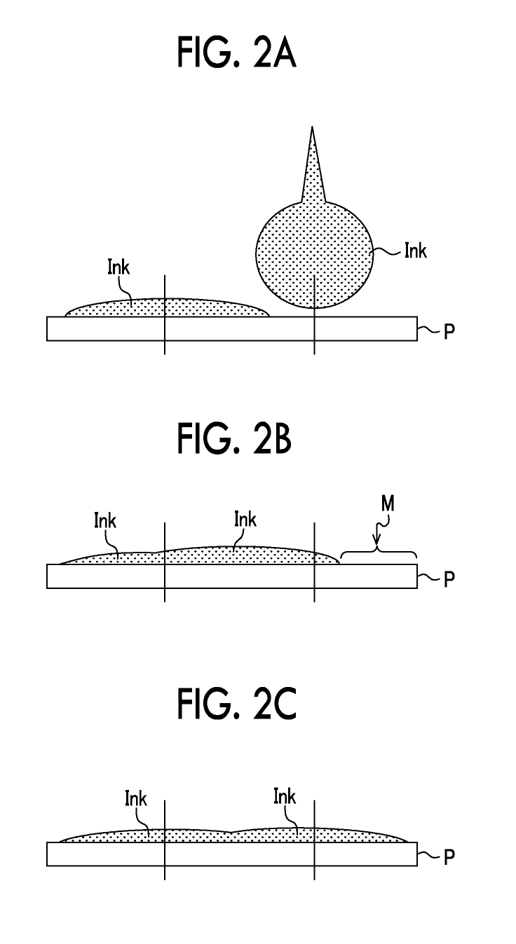

Here, if the ink is ejected to the non-permeable recording medium P, the ink landing on the recording medium P does not permeate or is not unlikely to permeate the recording medium P. Therefore, even when an ink droplet lands, the ink droplet remains to have a height on the surface of the recording medium P (see FIG. 2A). Also, the ink droplet spreads on the recording medium P. In this state, if a subsequent ink droplet lands adjacent to the previously landed ink droplet, the subsequent ink droplet contacts the ink droplet remaining near the subsequent ink droplet just before the landing and is coalesced so that the subsequent ink droplet may deviate from the landing position (see FIG. 2B). Specifically, compared with the case in which landing interference does not occur in the subsequent ink droplet (FIG. 2C), the landing position of the subsequent ink droplet may deviate to the previously landed ink droplet side (FIG. 2B). This phenomenon is called “landing interference”, and causes a stripe-shaped image defect (for example, white stripe-shaped image defect through which the background is seen) caused by the deviation of the ink droplet from the landing position. In addition, the expression “Ink” in FIG. 2 denotes ink. The expression “M” denotes a deviation of the landing position caused by landing interference of the ink droplets.

In order to prevent the landing interference, a technique of coating a liquid that coheres the previous ink droplet before the subsequent ink droplet lands is used. However, in a two-liquid system, this configuration becomes complicated, so the control thereof also becomes complicated.

Therefore, in the recording device 10 according to the exemplary embodiment, ink including a colorant, polymer particles, a light-absorbing and heat-generating agent, water, and an aqueous organic solvent is ejected to the recording medium P, and after the ink lands on the recording medium P, the landed ink is irradiated with light within 1 second. If the ink is irradiated with light within 1 second after landing of the ink, the light-absorbing and heat-generating agent included in the ink generates heat, drying of the ink proceeds, and the ink is thickened. That is, if the ink droplet that lands on the recording medium P is thickened, the ink droplet is likely to remain in the landing position. Also, if the thickening occurs within 1 second after landing of the ink droplet, even if landing interference occurs, the ink droplet is unlikely to deviate from the landing position.

Therefore, in the recording device 10 according to the exemplary embodiment, even in a single liquid system, landing interference is prevented, so the stripe-shaped image defects are prevented. In addition, irregular image defects is also likely to be prevented.

Here, the time between when the ink lands on the recording medium P, and when the landed ink starts to be irradiated with light is within 1 second, but the time is preferably within 500 milliseconds, and more preferably within 100 milliseconds. The starting time is adjusted, for example, according to the distance between the ejection head 122 and the light irradiation device 123, and the transportation speed of the recording medium P (recording speed).

Specifically, in the recording device 10 according to the exemplary embodiment, if ink of which the static surface tension is in the range of 22 mN/m to 30 mN/m, and of which, when a dynamic surface tension is measured by the maximum bubble pressure method, the difference between a value of the dynamic surface tension after 10 msec and a value of the dynamic surface tension after 1,000 msec (hereinafter referred to as “variation range of dynamic surface tension”) is equal to or greater than 2 mN/m, is applied as the ink, the landing interference is further prevented and the stripe-shaped image defects are likely to be prevented.

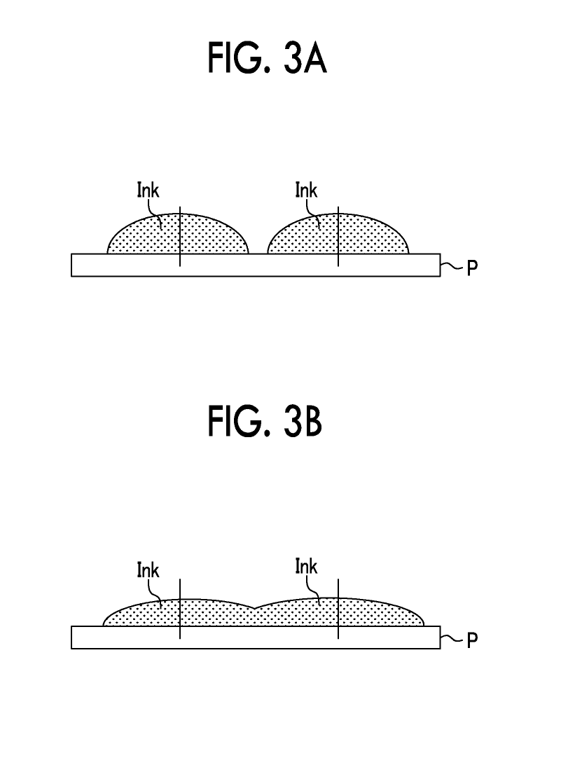

After the static surface tension of the ink is set to be in the range described above, the variation range of the dynamic surface tension is set to be great, that is, the initial dynamic surface tension is set to be great. Accordingly, the spreading of a previously landed ink droplet on the recording medium P is further prevented. In this case, an ink droplet subsequently landing adjacent to the previously landed ink droplet becomes unlikely to contact the ink droplet remaining adjacent thereto just before the landing thereof (see FIG. 3A). Thereafter, even if the previously landed ink droplet and the subsequently landed ink droplet slowly spread on the recording medium P, and the ink droplets are coalesced with each other, the drying of the ink progresses and the ink is thickened by the irradiation of the light, so the subsequent ink droplet is unlikely to deviate from the landing position (see FIG. 3B). Accordingly, the landing interference is more likely to be prevented. As a result, the stripe-shaped image defects are likely to be prevented. In addition, the irregular image defects are also likely to be prevented. In FIG. 3, the expression “Ink” denotes ink.

The reason that the stripe-shaped image defects are prevented is an assumed effect, and should not be construed as any sort of limitation.

Hereinafter, the ink applied to the recording device 10 according to the exemplary embodiment is described in detail.

The ink includes a colorant, polymer particles, a light-absorbing and heat-generating agent, water, and an aqueous organic solvent.

In view of preventing the stripe-shaped image defects, it is preferable that the ink have a static surface tension in the range of 22 mN/m to 30 mN/m and the variation range of the dynamic surface tension be equal to or greater than 2 mN/m.

In view of the ejection stability, the static surface tension of the ink is preferably in the range of 24 mN/m to 28 mN/m.

The static surface tension is a value measured in an environment of 23° C., 55% RH by using a Wilhelmy-type plate tensiometer CBVP-Z (manufactured by Kyowa Interface Science Co., Ltd).

In view of the prevention of the stripe-shaped image defects, the variation range of the dynamic surface tension of the ink is preferably in the range of 5 mN/m to 10 mN/m, and more preferably in the range of 7 mN/m to 10 mN/m.

The variation range of the dynamic surface tension (a difference between a value of the dynamic surface tension after 10 msec and a value of the dynamic surface tension after 1,000 msec when the dynamic surface tension is measured by the maximum bubble pressure method) is a value measured in an environment of 23° C., 55% RH by using a maximum bubble pressure dynamic surface tensiometer MPT C (manufactured by LAUDA-Brinkmann, LP).

In addition, the value of the dynamic surface tension after 10 msec is a value of the dynamic surface tension when the bubble pressure has reached the maximum 10 msec after a new interface is formed at the tip of the capillary, and the value of the dynamic surface tension after 1,000 msec is a value of the dynamic surface tension when the bubble pressure has reached the maximum 1,000 msec after a new interface is formed at the tip of the capillary.

Here, in order to set the static surface tension and the variation ranges of the dynamic surface tension of the ink to be in the ranges described above, the ink may preferably include, for example, an ethylene oxide adduct of acetylene glycol or an ethylene oxide adduct of acetylene glycol and a polyether-modified silicone, in addition to the colorant, the polymer particles, the light-absorbing and heat-generating agent, the water, and the aqueous organic solvent. In particular, the ink preferably includes an ethylene oxide adduct of acetylene glycol, and a polyether-modified silicone.

In the ink, the content of the ethylene oxide adduct of acetylene glycol may be, for example, in the range of 0.01% by weight to 10% by weight, or preferably in the range of 0.1% by weight to 5% by weight with respect to the ink.

In addition, the content of the polyether-modified silicone may be, for example, in the range of 0.01% by weight to 5% by weight, and preferably in the range of 0.05% by weight to 1% by weight with respect to the ink.

The ethylene oxide adduct of acetylene glycol includes, for example, Olfine E1010, Olfine PD-002W, Olfine EXP.4001, Olfine EXP.4123, and Olfine EXP.4300 (manufactured by Nissin Chemical Co., Ltd.), as commercial products of the ethylene oxide adduct of acetylene glycol, for example, which is a compound having a —O—(CH₂CH₂O)ₙ—H structure (also, for example, n denotes an integer in the range of 1 to 30) in which ethylene oxide is added to at least one hydroxyl group of acetylene glycol.

The polyether-modified silicone is, for example, a compound in which a polyether group is coupled to a silicone chain (polysiloxane main chain) in a graft form or in a block form. As a polyether group, a polyoxyethylene group and a polyoxypropylene group are included. A polyether group may be a polyoxyalkylene group in which an oxyethylene group and an oxypropylene group are added in a block form or randomly.

As a commercial product of the polyether-modified silicone, Silface SAG002 and Silface SAG503A (manufactured by Nissin Chemical Co., Ltd.) are included.

Next, the composition and the characteristics of the ink will be described.

A colorant will be described.

As a colorant, a pigment is included. As a pigment, an organic pigment and an inorganic pigment are included.

As a specific example of the black pigment, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080, and Raven 1060 (manufactured by Columbian Carbon Japan Ltd.), Regal 400R, Regal 330R, Regal 660R, Mogul L, Black Pearls L, Monarch 700, Monarch 800, Monarch 880, Monarch 900, Monarch 1000, Monarch 1100, Monarch 1300, and Monarch 1400 (manufactured by Cabot Corporation), Color Black FW1, Color Black FW2, Color Black FW2V, Color Black 18, Color Black FW200, Color Black 5150, Color Black 5160, Color Black 5170, Printex 35, Printex U, Printex V, Printex 140U, Printex 140V, Special Black 6, Special Black 5, Special Black 4A, and Special Black 4 (manufactured by Degussa AG), and No. 25, No. 33, No. 40, No. 47, No. 52, No. 900, No. 2300, MCF-88, MA600, MA7, MA8, and MA100 (manufactured by Mitsubishi Chemical Corporation) are included, but the black pigment is not limited thereto.

As a specific example of the cyan pigment, C. I. Pigment Blue 1, C. I. Pigment Blue 2, C. I. Pigment Blue 3, C. I. Pigment Blue 15, C. I. Pigment Blue 15:1, C. I. Pigment Blue 15:2, C. I. Pigment Blue 15:3, C. I. Pigment Blue 15:4, C. I. Pigment Blue 16, C. I. Pigment Blue 22, and C. I. Pigment Blue 60 are included, but the cyan pigment is not limited thereto.

As a specific example of the magenta pigment, C. I. Pigment Red 5, C. I. Pigment Red 7, C. I. Pigment Red 12, C. I. Pigment Red 48, C. I. Pigment Red 48:1, C. I. Pigment Red 57, C. I. Pigment Red 112, C. I. Pigment Red 122, C. I. Pigment Red 123, C. I. Pigment Red 146, C. I. Pigment Red 168, C. I. Pigment Red 177, C. I. Pigment Red 184, and C. I. Pigment Red 202, and C. I. Pigment Violet 19 are included, but the magenta pigment is not limited thereto.

As a specific example of the yellow pigment, C. I. Pigment Yellow 1, C. I. Pigment Yellow 2, C. I. Pigment Yellow 3, C. I. Pigment Yellow 12, C. I. Pigment Yellow 13, C. I. Pigment Yellow 14, C. I. Pigment Yellow 16, C. I. Pigment Yellow 17, C. I. Pigment Yellow 73, C. I. Pigment Yellow 74, C. I. Pigment Yellow 75, C. I. Pigment Yellow 83, C. I. Pigment Yellow 93, C. I. Pigment Yellow 95, C. I. Pigment Yellow 97, C. I. Pigment Yellow 98, C. I. Pigment Yellow 114, C. I. Pigment Yellow 128, C. I. Pigment Yellow 129, C. I. Pigment Yellow 138, C. I. Pigment Yellow 151, C. I. Pigment Yellow 154, and C. I. Pigment Yellow 180 are included, but the yellow pigment is not limited thereto.

Here, when the pigment is used as the colorant, it is preferable to use a pigment dispersant in combination. An example of the pigment dispersant used includes a polymeric dispersant, an anionic surfactant, a cationic surfactant, an amphoteric surfactant, and a nonionic surfactant.

As the polymeric dispersant, a polymer having a hydrophilic structure portion and a hydrophobic structure portion is preferably used. As the polymer having the hydrophilic structure portion and the hydrophobic structure portion, for example, a condensation polymer and an addition polymer are used. As a condensation polymer, well-known polyester dispersants are included. As the addition polymer, an addition polymer of a monomer having an α,β-ethylenically unsaturated group is included. A target polymeric dispersant may be obtained by combining and copolymerizing a monomer having an α,β-ethylenically unsaturated group having a hydrophilic group and a monomer having an α,β-ethylenically unsaturated group having a hydrophobic group. In addition, a homopolymer of a monomer having an α,β-ethylenically unsaturated group having a hydrophilic group is also used.

As the monomer having an α,β-ethylenically unsaturated group having a hydrophilic group, a monomer having a carboxyl group, a sulfonate group, a hydroxyl group, and a phosphate group, for example, acrylic acid, methacrylic acid, crotonic acid, itaconic acid, an itaconic acid monoester, maleic acid, a maleic acid monoester, fumaric acid, a fumaric acid monoester, a vinyl sulfonic acid, a styrene sulfonic acid, sulfonated vinylnaphthalene, a vinyl alcohol, acrylamide, a methacryloxyethyl phosphate, a bismethacryloxyethyl phosphate, a methacryloxyethyl phenyl acid phosphate, ethylene glycol dimethacrylate, and diethylene glycol dimethacrylate are included.

As the monomer having an α,β-ethylenically unsaturated group having a hydrophobic group, styrene derivatives such as styrene, α-methylstyrene, and vinyl toluene, vinylcyclohexane, vinylnaphthalene, vinylnaphthalene derivatives, an acrylic acid alkyl ester, a methacrylic acid alkyl ester, a methacrylic acid phenyl ester, a methacrylic acid cycloalkyl ester, a crotonic acid alkyl ester, an itaconic acid dialkyl ester, and a maleic acid dialkyl ester are included.

As an example of a copolymer preferable as the polymeric dispersant, a styrene-styrene sulfonic acid copolymer, a styrene-maleic acid copolymer, a styrene-methacrylic acid copolymer, a styrene-acrylic acid copolymer, a vinylnaphthalene-maleic acid copolymer, a vinylnaphthalene-methacrylic acid copolymer, a vinylnaphthalene-acrylic acid copolymer, an acrylic acid alkyl ester-acrylic acid copolymer, a methacrylic acid alkyl ester-methacrylic acid copolymer, a styrene-methacrylic acid alkyl ester-methacrylic acid copolymer, a styrene-acrylic acid alkyl ester-acrylic acid copolymer, a styrene-methacrylic acid phenyl ester-methacrylic acid copolymer, and a styrene-methacrylic acid cyclohexyl ester-methacrylic acid copolymer are included. In addition, a monomer having a polyoxyethylene group and a hydroxyl group may be copolymerized with these polymers.

A weight-average molecular weight of a polymeric dispersant may preferably be, for example, in the range of 2,000 to 50,000.

These polymeric dispersants may be used singly or by combining two or more kinds. The content of the polymeric dispersant is not clearly defined since it greatly varies according to the pigment, but the content may preferably be in the range of 0.1% by weight to 100% by weight with respect to the pigment.

As the pigment, a pigment self-dispersed in water (hereinafter referred to as a self-dispersing pigment) is also included.

The self-dispersing pigment indicates a pigment having a group soluble in water on a pigment surface, and being dispersed in water even if a polymeric dispersant does not exist. The self-dispersing pigment may be obtained, for example, by performing a surface modification process such as an acid-base process, a coupling agent process, a polymer graft process, a plasma process, and an oxidation-reduction process, on the pigment.

As the self-dispersing pigment, in addition to the pigments obtained by performing a surface modification process on the pigment, commercially available self-dispersing pigments such as Cab-o-jet-200, Cab-o-jet-300, Cab-o-jet-400, IJX-157, IJX-253, IJX-266, IJX-273, IJX-444, IJX-55, Cab-o-jet-250C, Cab-o-jet-260M, Cab-o-jet-270Y, Cab-o-jet-450C, Cab-o-jet-465M, Cab-o-jet-470Y, and Cab-o-jet-480M manufactured by Carbot Corporation, and Microjet Black CW-1 and CW-2 manufactured by Orient Chemical Industries, Ltd. are included.

As the self-dispersing pigment, a pigment having at least a sulfonic acid, a sulfonate, a carboxylic acid, or a carboxylate as a functional group on the surface thereof is preferable. A pigment having at least a carboxylic acid, or carboxylate as a functional group on the surface thereof is more preferable.

Here, as the pigment, a pigment covered with a resin and the like are included. These are called microcapsule pigments, and include commercially available microcapsule pigments manufactured by DIC Corporation, Toyo Ink Co., Ltd., and the like. In addition, the microcapsule pigment is not limited to commercially available microcapsule pigments, and microcapsule pigments manufactured according to a purpose may be used.

As the pigment, a resin dispersion pigment in which a polymeric compound is physically adsorbed into or chemically combined with a pigment is included.

As the pigment, in addition to pigments of black and three primary colors of cyan, magenta, and yellow, pigments of specific colors of red, green, blue, brown, white, and the like, or pigments of metallic lusters of gold, silver, and the like, extender pigments being colorless or having a pale color, plastic pigments, and the like are also included.

As the pigment, particles in which silica, alumina, or polymer beads are used as cores, and dyes or pigments are fixed to the surfaces thereof, an insoluble lake material dye, a colored emulsion, colored latex, and the like are included.

As the colorant, in addition to the pigments, a dye such as a hydrophilic anion dye, a direct dye, a cationic dye, a reactive dye, or a polymeric dye, or an oil-soluble dye, wax powders and resin powders or emulsions which are colored by a dye, a fluorescent dye, a fluorescent pigment, and the like are included.

A volume average particle diameter of the colorant is, for example, in the range of 10 nm to 1,000 nm.

The volume average particle diameter of the colorant refers to a diameter of the colorant itself, or a diameter of the colorant with an additive attached, when an additive such as a dispersant is attached. The volume average particle diameter is measured by a Microtrac UPA particle size analyzer UPA-UT151 (manufactured by Microtrac Inc.). The measurement is performed by putting ink diluted 1,000 times into a measurement cell. In addition, as the input value at the time of the measurement, the viscosity is set to be the viscosity of the ink diluting fluid, and the particle refractive index is set to be the refractive index of the colorant.

The content (concentration) of the colorant is, for example, preferably in the range of 1% by weight to 25% by weight, and more preferably in the range of 2% by weight to 20% by weight with respect to the ink.

The polymer particles will be described.

The polymer particles are a component that enhances the fixing property of the image by the ink to the non-permeable recording medium.

As the polymer particles, for example, particles (latex particles) of a styrene-acrylic acid copolymer, a styrene-acrylic acid-sodium acrylate copolymer, a styrene-butadiene copolymer, polystyrene, an acrylonitrile-butadiene copolymer, an acrylic ester copolymer, polyurethane, a silicon-acrylic acid copolymer, and an acrylic-modified fluororesin are included. As the polymer particles, core-shell type polymer particles in which compositions are different in a center portion and an outer edge portion of the particle are included.

The polymer particles may be particles which are dispersed in the ink by using an emulsifier, or dispersed in the ink without using an emulsifier. As the emulsifier, a surfactant, a polymer having a hydrophilic group such as a sulfonic acid group, and a carboxyl group (for example, a polymer in which a hydrophilic group is grafted, and a polymer obtained from a hydrophilic monomer or a monomer having a hydrophobic portion) are included.

In view of the glossiness and the abrasion resistance of the image, the volume average particle diameter of the polymer particles is preferably in the range of 10 nm to 300 nm, and more preferably in the range of 10 nm to 200 nm.

The volume average particle diameter of the polymer particles is measured by a Microtrac UPA particle size analyzer UPA-UT151 (manufactured by Microtrac Inc.). The measurement is performed by putting ink diluted 1,000 times into a measurement cell. In addition, as the input value at the time of the measurement, the viscosity is set to be the viscosity of the ink diluting fluid, and the particle refractive index is set to be the refractive index of the polymer.

In view of the abrasion resistance of the image, the glass transition temperature of the polymer particles is preferably in the range of −20° C. to 80° C., and more preferably in the range of −10° C. to 60° C.

The glass transition temperature of the polymer particles is determined from a DSC curve obtained by differential scanning calorimetry (DSC), and more specifically calculated from “extrapolating glass transition starting temperature” described in the method of calculating a glass transition temperature of JIS K7121-1987 “Testing Methods for Transition Temperatures of Plastics”.

The content of the polymer particles is preferably in the range of 0.1% by weight to 10% by weight, and more preferably in the range of 0.5% by weight to 5% by weight with respect to the ink.

The light-absorbing and heat-generating agent will be described.

The light-absorbing and heat-generating agent is not particularly limited as long as it is a compound that absorbs light and emits heat. In addition, the light-absorbing and heat-generating agent may also function as the colorant. In this case, there is an aspect in which a colorant having a light-absorbing and heat-generating function (for example, a black pigment such as carbon black that also functions as the infrared light absorbing agent) is included in the ink as the colorant and the light-absorbing and heat-generating agent.

The light-absorbing and heat-generating agent may be a water-soluble light-absorbing and heat-generating agent, or may be a water-insoluble light-absorbing and heat-generating agent. Here, for the light-absorbing and heat-generating agent, water solubility means that the dissolution amount of the object substance with respect to 100 parts by weight of water at 25° C. is equal to or greater than 0.1 parts by weight. Meanwhile, water insolubility means that the dissolution amount of the object substance with respect to 100 parts by weight of water at 25° C. is less than 0.1 parts by weight.

In addition, when a water-insoluble light-absorbing and heat-generating agent is used, the water-insoluble light-absorbing and heat-generating agent may be dispersed in the aqueous ink by being emulsified by a known method using a dispersant or the like, or may be dispersed in the ink by being dissolved and dispersed by a water-soluble organic solvent.

As the light-absorbing and heat-generating agent, for example, an ultraviolet light absorbing agent, an infrared light absorbing agent, and the like are included. In addition, as the light-absorbing and heat-generating agent, the ultraviolet light absorbing agent and the infrared light absorbing agent may be used in combination.

As the infrared light absorbing agent, for example, a cyanine compound, a diimmonium compound, and an aluminum compound are included.

As a specific example of the infrared light absorbing agent, for example, “KAYASORB IRG-140” manufactured by Nippon Kayaku Co., Ltd., “KAYASORB IRG-022” manufactured by Nippon Kayaku Co., Ltd., “KAYASORB CY-40MC” manufactured by Nippon Kayaku Co., Ltd., “NIR-IM1” manufactured by Nagase ChemteX Corporation, and “NIR-AM1” manufactured by Nagase ChemteX Corporation are included.

The infrared light absorbing agent may be used singly, and two or more kinds thereof may be used in combination.

As the ultraviolet light absorbing agent, for example, benzophenone, benzotriazole, salicylic acid ester, oxalic acid amide, and nickel complex salt ultraviolet light absorbing agents and the like are included.

The ultraviolet light absorbing agent may be used singly, or two or more kinds thereof may be used in combination.

The content of the light-absorbing and heat-generating agent is, for example, preferably in the range of 0.01% by weight to 1% by weight, and more preferably in the range of 0.05% by weight to 0.5% by weight with respect to the ink. However, this does not always apply when the light-absorbing and heat-generating agent is also used as the colorant.

The water will be described.

In view of preventing, in particular, mixing in of impurities and the occurrence of microorganisms, the water may be ion exchanged water, ultra pure water, distilled water, or ultrafiltered water.

The content of water is, for example, preferably in the range of 10% by weight to 95% by weight, and more preferably in the range of 30% by weight to 90% by weight with respect to the ink.

The water-soluble organic solvent will be described.

As the water-soluble organic solvent, polyols, derivatives of polyols, a nitrogen-containing solvent, alcohols, a sulfur-containing solvent, and the like are included. As the water-soluble organic solvent, in addition, propylene carbonate, ethylene carbonate and the like are included.

As the polyols, sugar alcohols such as ethylene glycol, diethylene glycol, propylene glycol, butylene glycol, triethylene glycol, 1,5-pentanediol, 1,2-hexanediol, 1,2,6-hexanetriol, glycerol, trimethylolpropane, and xylitol; and saccharides such as xylose, glucose, and galactose are included.

As the derivatives of polyols, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, an ethylene oxide adduct of diglycerol and the like are included.

As the nitrogen-containing solvent, pyrrolidone, N-methyl-2-pyrrolidone, cyclohexylpyrrolidone, triethanolamine, and the like are included.

As the alcohols, ethanol, isopropyl alcohol, butyl alcohol, benzyl alcohol, and the like are included.

As the sulfur-containing solvent, thiodiethanol, thiodiglycerol, sulfolane, dimethyl sulfoxide, and the like are included.

The water-soluble organic solvent may be used singly, or two or more types thereof may be used in combination.

The content of the water-soluble organic solvent is preferably in the range of 1% by weight to 60% by weight, and more preferably in the range of 1% by weight to 40% by weight with respect to water.

The surfactant will be described.

In the ink, a surfactant may be included. As the surfactant, an anionic surfactant, a nonionic surfactant, a cationic surfactant, an amphoteric surfactant, and the like are included, and an anionic surfactant and a nonionic surfactant are preferable.

As the anionic surfactant, an alkylbenzene sulfonate, an alkylphenyl sulfonate, an alkylnaphthalene sulfonate, a higher fatty acid salt, a sulfate ester salt of a higher fatty acid ester, a sulfonate of a higher fatty acid ester, a sulfonate ester salt and sulfonate of a higher alcohol ether, a higher alkyl sulfosuccinate, polyoxyethylene alkyl ether carboxylate, a polyoxyethylene alkyl ether sulfate, an alkyl phosphate, and a polyoxyethylene alkyl ether phosphate are included.

Among these, the anionic surfactant may be a dodecyl benzene sulfonate, an isopropyl naphthalene sulfonate, a monobutyl phenylphenol monosulfonate, a monobutyl biphenyl sulfonate, a dibutyl phenylphenol disulfonate, and the like.

As the nonionic surfactant, a polyoxyethylene alkyl ether, a polyoxyethylene alkylphenyl ether, a polyoxyethylene fatty acid ester, a sorbitan fatty acid ester, a polyoxyethylene sorbitan fatty acid ester, a polyoxyethylene sorbitol fatty acid ester, a glycerol fatty acid ester, a polyoxyethylene glycerol fatty acid ester, a polyglycerol fatty acid ester, a sucrose fatty acid ester, a polyoxyethylene alkyl amine, a polyoxyethylene fatty acid amide, an alkyl alkanolamide, a polyethylene glycol polypropylene glycol block copolymer, acetylene glycol, and the like are included.

Among these, the nonionic surfactant may preferably be a polyoxyethylene nonylphenyl ether, a polyoxyethylene octyl phenyl ether, a polyoxyethylene dodecyl phenyl ether, a polyoxyethylene alkyl ether, a polyoxyethylene fatty acid ester, a sorbitan fatty acid ester, a polyoxyethylene sorbitan fatty acid ester, a fatty acid alkylol amide, a polyethylene glycol polypropylene glycol block copolymer, and acetylene glycol.

As the nonionic surfactant, in addition, a silicone surfactant such as a polysiloxane oxyethylene adduct; a fluorine surfactant such as a perfluoroalkyl carboxylate, a perfluoroalkylsulfonate, and an oxyethylene perfluoroalkyl ether; and a biosurfactant such as spiculisporic acid, rhamnolipid, and lysolecithin are included.

If the solubility is considered, the hydrophilic/lipophilic balance (HLB) of the surfactant may preferably be, for example, in the range of 3 to 20.

The surfactant may be used singly, or two or more kinds thereof may be used in combination.

The content of the surfactant is preferably in the range of 0.1% by weight to 10% by weight, more preferably in the range of 0.1% by weight to 5% by weight, and still more preferably in the range of 0.2% by weight to 3% by weight with respect to the ink.

Other additives will be described.

In the ink, other additives may be included. As other additives, an ink ejection improving agent (polyethyleneimine, polyamines, polyvinylpyrrolidone, polyethylene glycol, ethyl cellulose, carboxymethyl cellulose, and the like), a conductivity/pH adjusting agent (compounds of alkali metals such as potassium hydroxide, sodium hydroxide, and lithium hydroxide), a reactive diluting solvent, a penetrating agent, a pH buffer agent, an antioxidant, an antifungal agent, a viscosity adjusting agent, a conductive material, a chelating agent, and the like are included.

Preferable physical properties of the ink will be described.

The pH of the ink is preferably in the range of 4 to 10, more preferably in the range of 5 to 9.

Here, a value measured by a pH/conductivity meter (MPC227 manufactured by Mettler-Toledo International Inc.) in an environment of a temperature of 23±0.5° C., and a humidity of 55±5% R.H. is adopted for the pH of the ink.

The conductivity of the ink is, for example, in the range of 0.01 S/m to 0.5 S/m (preferably in the range of 0.01 S/m to 0.25 S/m, and more preferably in the range of 0.01 S/m to 0.20 S/m).

The conductivity is measured by an MPC227 (a pH/Conductivity Meter manufactured by Mettler-Toledo International Inc.).

The viscosity of the ink is, for example, in the range of 1.5 mPa·s to 30 mPa·s (preferably in the range of 1.5 mPa·s to 20 mPa·s).

The viscosity is measured by using a TV-20 (manufactured by Toki Sangyo Co., Ltd.) as a measurement apparatus, in the conditions in which the measurement temperature is 23° C., and the shear velocity is 1,400 s⁻¹.

In the recording device 10 according to the exemplary embodiment, the method of directly ejecting ink droplets on the surface of the recording medium P with the ejection device 121 (the ejection head 122) is described. However, the invention is not limited thereto, and may be a method of ejecting ink droplets to an intermediate transfer member and transferring the ink droplets on the intermediate transfer member to the recording medium P.

In the recording device 10 according to the exemplary embodiment, the method of recording an image by ejecting the ink on the continuous paper P as the recording medium P is described, but the invention may be a method of recording an image by ejecting ink on a paper sheet as the recording medium P.

In addition, the exemplary embodiment is not construed in a limit way, and is obtained in the scope of satisfying the requirements of the invention.

### EXAMPLES

Hereinafter, the invention is specifically described with reference to examples, but the invention is not limited to these examples.

Recording Device 1

Preparation of Main Body of Recording Device

With the same configuration as the configuration illustrated in FIG. 1, a main body of a recording device (however, main body of recording device performing recording on a paper sheet as recording medium) including a 1,200 dpi piezo head (maximum ink droplet amount of 9 pl) as an ejection head for the ink is prepared. The details of the main body of the prepared recording device are as described below. In addition, the main body of the recording device is as follows.

Details of Main Body of Recording Device
Recording speed (transportation speed of recording medium): 50 m/min
Light irradiation device: Infrared laser irradiation device (center wavelength=800 nm, irradiation intensity=1.5 mJ/m², and irradiation time=100 milliseconds)
Arrangement position of light irradiation device: position at which distance from ejection head in transportation direction of recording medium is 8.35 mm (position at which landed ink is irradiated with infrared laser when 100 milliseconds had elapsed after ink ejected from ejection head lands on recording medium)
Non-permeable recording medium: “OK TOPCOAT+” manufactured by Oji Paper Co., Ltd. (ream weight of 43 kg)

Preparation of Ink
CAB-O-JET 400 (manufactured by Cabot Corporation): 8% by weight
TOCRYL W-4627 (acrylic emulsion manufactured by Toyochem Co., Ltd.): 5% by weight

Solid Content

(Polymer particles, volume average particle diameter=0.12 μm, glass transition temperature=45° C.)
Diethylene glycol: 5% by weight
Glycerol: 15% by weight
Surfactant (compound presented in Table 1): % by weight presented in Table 1
Ion exchanged water: the balance

After the compositions described above are mixed, filtration is performed with a 5 μm filter to obtain aqueous ink.

Also, an ink tank of the main body of the recording device is filled with the prepared ink to obtain a recording device 1.

Recording Devices 2 to 5 and 11 to 13

Ink is prepared in the same manner as that for the recording device 1, except that the types and the amounts (% by weight) of the surfactant are changed in accordance with Table 1. Also, in the same manner as that for the recording device 1, the ink tank of the main body of the recording device is filled with the prepared ink to obtain the recording devices 1 to 5 and 11 to 13.

Evaluation

Ink is ejected from the respective 1,200 dpi piezo heads (maximum ink droplet amount of 9 pl) on “OK TOPCOAT+” manufactured by Oji Paper Co., Ltd., as the non-permeable recording medium, to forma 1.5 cm×1.5 cm solid image by using the respective recording devices. Thereafter, when 100 milliseconds had elapsed after the ink ejected from the ejection heads lands on the recording medium, the landed ink is irradiated with infrared laser beams by an infrared laser irradiation device, is dried, and is cooled down by the cooling roller. After these processes, an image is recorded by the ink on the non-permeable recording medium.

Further, the image after the recording is visually observed to evaluate the peeling of the image caused by the drying failure, stripe-shaped image defects, or irregular image defects (landing interference, image defect caused by ejection failure).

Meanwhile, images are formed on the non-permeable recording medium by the ink by using the respective recording devices in the same manner, except that, when two seconds had elapsed after the ink ejected from the ejection heads landed on the recording medium, the landed ink is irradiated with infrared laser beams by an infrared laser irradiation device, and these images are evaluated as well.

Evaluation criteria are as follows.

Image Peeling Evaluation Criteria

A+: Image does not peel off

A: Image peels off slightly

B: Portion of image peels off

C: Image peels off and is significantly contaminated

Evaluation Criteria of Stripe-Shaped or Irregular Image Defects

A+: Neither stripe-shaped image defects nor irregular image defects are present

A: Both of stripe-shaped image defects and irregular image defects are slightly present

B: Stripe-shaped image defects and irregular image defects are present on a portion of the image

C: Character recognition is difficult since stripe-shaped image defects and irregular image defects are present

TABLE 1

| | Types and amounts of surfactant | | | | | |
|---|---|---|---|---|---|---|
| | E1010 | PD-002W | EXP.4001 | EXP.4123 | SAG002 | SAG503A |
| Recording device 1 | 0.4 | | | | | |
| Recording device 2 | 0.4 | | | | | 0.05 |
| Recording device 3 | 1 | | 0.1 | | | |
| Recording device 4 | 0.4 | | | | | 0.2 |
| Recording device 5 | 0.2 | | | | 0.1 | |
| Recording device 11 | 0.5 | 0.2 | | | | |
| Recording device 12 | 1 | | | 1 | | |
| Recording device 13 | 1 | | | | | |

TABLE 2

| | | | Evaluation | | | |
|---|---|---|---|---|---|---|
| | Characteristics of ink | | Infrared laser irradiation | | Infrared laser irradiation | |
| | | Variation | when 100 milliseconds | | when 2 seconds had | |
| | | range of | had elapsed after | | elapsed after | |
| | Static | dynamic | landing of ink | | landing of ink | |
| | surface | surface | | Stripe-shaped | | Stripe-shaped |
| | tension | tension | Image | or irregular | Image | or irregular |
| | (N/m) | (N/m) | peeling | image defects | peeling | image defects |
| Recording device 1 | 24 | 10 | A+ | A | C | C |
| Recording device 2 | 26 | 5 | A+ | A | B | B |
| Recording device 3 | 30 | 8 | A+ | A | C | C |
| Recording device 4 | 22 | 7 | A+ | A | B | B |
| Recording device 5 | 24 | 3 | A+ | A | A | B |
| Recording device 11 | 22 | 1 | A+ | A | A | A |
| Recording device 12 | 26 | 1 | A+ | A | B | A |
| Recording device 13 | 28 | 1 | A+ | A | B | A |

| | | |
|---|---|---|
| Remarks | Example | Comparative Example |

From the results, it is found that in the recording device according to Examples, the stripe-shaped image defects are prevented compared with the recording device according to Comparative Examples.

In addition, it is found that in the recording device according to Examples, the irregular image defects and the image peeling are also prevented compared with the recording device according to Comparative Examples.

In addition, details of the abbreviations in Table 1 are as follows.

Ethylene Oxide Adducts of Acetylenediol
E1010: Olfine E1010 (manufactured by Nissin Chemical Co., Ltd.)
PD-002W: Olfine PD-002W (manufactured by Nissin Chemical Co., Ltd.)
EXP.4001: Olfine EXP.4001 (manufactured by Nissin Chemical Co., Ltd.)
EXP.4123: Olfine EXP.4123 (manufactured by Nissin Chemical Co., Ltd.)

Polyether-Modified Silicone
SAG002: Silface SAG002 (manufactured by Nissin Chemical Co., Ltd.)
SAG503A: Silface SAG503A (manufactured by Nissin Chemical Co., Ltd.)

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording device comprising:
an ejection head that ejects aqueous ink including a colorant, polymer particles, a light-absorbing and heat-generating agent, water, and an aqueous organic solvent; and
a light irradiation device that irradiates the aqueous ink with light within one second after the aqueous ink ejected from the ejection head lands.

2. The recording device according to claim 1,
wherein a static surface tension of the aqueous ink is in a range of 22 mN/m to 30 mN/m, and
wherein when a dynamic surface tension of the aqueous ink is measured by a maximum bubble pressure method, a difference between a value of the dynamic surface tension after 10 msec and a value of the dynamic surface tension after 1,000 msec is equal to or greater than 2 mN/m.

3. A recording method comprising:
ejecting aqueous ink including a colorant, polymer particles, a light-absorbing and heat-generating agent, water, and an aqueous organic solvent on a recording medium; and
irradiating the aqueous ink with light within one second after the aqueous ink ejected from the ejection head lands on the recording medium.

4. The recording method according to claim 3,
wherein a static surface tension of the aqueous ink is in a range of 22 mN/m to 30 mN/m, and
wherein when a dynamic surface tension of the aqueous ink is measured by a maximum bubble pressure method, a difference between a value of the dynamic surface tension after 10 msec and a value of the dynamic surface tension after 1,000 msec is equal to or greater than 2 mN/m.
